(19) United States
(12) Patent Application Publication
(10) Pub. No.: US 2003/0159678 A1
(43) Pub. Date: Aug. 28, 2003

(54) Device for damping pressure pulsations in high-pressure injection systems

(76) Inventors: Walter Egler, Gerlingen (DE); Peter Boehland, Marbach (DE); Sebastian Kanne, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/240,936

(22) PCT Filed: Feb. 1, 2002
(86) PCT No.: PCT/DE02/00372

(30) Foreign Application Priority Data
Feb. 5, 2001 (DE) 101 05 031.3

(51) Int. Cl. F02M 1/00

(52) U.S. Cl. 123/447; 123/467

(57) ABSTRACT

The invention relates to a device for injecting fuel into the combustion chambers of an internal combustion engine, with a pump (2), which supplies highly pressurized fuel to a high-pressure accumulation chamber (3). Starting from this high-pressure accumulation chamber (3), a high-pressure supply line leads to an injector (5), which contains a metering valve (7) that acts on an injection nozzle (24) with fuel. The metering valve (7) is associated with a damping throttle (26), which is connected to a part of the high-pressure region.

### TECHNICAL FIELD

Pressure-controlled injection systems with high-pressure reservoirs (common rails) are being developed as an alternative to the currently standard stroke-controlled high-pressure injection systems. These systems contain a metering valve, which decouples the nozzle from the high-pressure line and connects it to the low-pressure side of the fuel injection system and vice versa. The switching of the metering valve generates a pressure wave in the high-pressure line, which gives rise to a pressure increase that causes a pressure increase in the nozzle, for example from a high-pressure reservoir pressure of 1350 bar to an injection nozzle pressure of over 1800 bar.

### PRIOR ART

With pressure-controlled systems for fuel injection in internal combustion engines, with a high-pressure reservoir pressure of approximately 1350 bar, injection pressures of 1800 bar and above are produced in the injection nozzles protruding into the individual combustion chambers of the internal combustion engine. With a relatively moderate pressure load on the pump of the fuel injection system, extremely high pressures are achieved in the nozzles.

A pressure-controlled reservoir injection system is essentially comprised of a high-pressure fuel pump, a high-pressure reservoir (common rail), and one high-pressure supply line per combustion chamber of an engine. The high-pressure supply line connects the high-pressure reservoir (common rail) to a nozzle holder combination. The fuel volume to be injected into the combustion chambers of the engine is metered by means of a 3/2-port directional-control valve, i.e. the metering valve. This valve can be disposed between the high-pressure line and the nozzle holder combination and can be screw connected to the nozzle holder combination or integrated into it.

In the normal position, the metering valve decouples the injection nozzle from the high-pressure line and connects it to the low-pressure side of the fuel injection system. The injection is produced by virtue of the fact that the 3/2-port directional-control valve functioning as the metering valve, when switched, connects the injection nozzle and the high-pressure line to each other and simultaneously closes the return to the low-pressure side of the fuel injection system. The pressure increase, for example from a pressure of 1350 bar in the high-pressure accumulation chamber to an injection pressure of approximately 1800 bar, is achieved by virtue of the fact that the high-pressure supply line of the injection nozzle or of the nozzle chamber encompassing the nozzle needle is of a sufficient length. The friction between the tube wall and the fluid damps the oscillation in the high-pressure supply line only slightly. It is also disadvantageous that continuous high pressure amplitudes in the high-pressure line and in the non-pressure-relieved region of the metering valve can have a negative impact on the fatigue strength of these components of the fuel injection system.

### Depiction of the Invention

With the embodiment proposed according to the invention, the placement of damping throttles and damping valves can very rapidly damp pressure oscillations that occur on the high-pressure side of a fuel injection system, before the occurrence of excessively high pressure amplitudes in the components of a fuel injection system. Due to the low friction between the wall of the line system and the highly pressurized fuel, pressure oscillations that occur are damped as rapidly as possible since the friction prevailing in these systems is not sufficient for damping. The throttle cross sections, lengths, and diameters of damping elements used in the reservoir injection system designed according to the invention are dimensioned so that the pressure increase for the injection, which occurs in the injector after the closing of the metering valve (for example a 3/2-port directional-control valve), is maintained to the greatest degree possible.

The return lines from the metering valve can either be connected to the high-pressure reservoir or can feed into a region of the high-pressure line remote from the metering valve. This return can be open all the time or can be switched by means of an additional valve so that it is closed during the injection phase. This assures that the injection pressure generated does not decrease in an undesirable fashion by means of the damping line. At the high pressures that prevail during the injection, after the metering valve closes, a pressure increase is produced in the injection system and pressure oscillations occur; providing the damping element proposed according to the invention in the form of a throttle element in the high-pressure region can prevent this effect, which would contribute to a premature aging of the material of the components of the fuel injection system.

If a higher pressure prevails at the metering valve than in the high-pressure accumulation chamber (common rail), then fuel flows through the throttle elements into the return line. If the pressure at the metering valve is less than that in the high-pressure accumulation chamber (common rail), then a pressure balance at the metering valve sets in so that the fuel injection system proposed according to the invention has a tendency toward pressure balance.

By using the concept according to the invention, advantage can be taken of the pressure differences in the high-pressure lines leading to the individual injectors of a fuel injection system in that the high-pressure lines leading to the injectors can be connected to each other in pairs by means of damping lines. The damping lines, which connect the high-pressure supply lines to each other, can be provided at the beginning and end with damping elements in the form of damping throttles. The damping lines can be connected to their high-pressure lines independent of the injector design so that the injector can remain essentially unchanged and no modifications to it are required.

### DRAWINGS

The invention will be explained in detail below in conjunction with the drawings.

FIG. 1 shows the components of a pressure-controlled injection system for the injection of fuel, with oscillation dampers,

FIGS. 2, 3 show an injector body with a damping function, in different sectional views, along with two cross sections A—A and B—B,

FIGS. 4a-d show stroke curves and pressure curves in the pressure-controlled injection system, with oscillation/pulsation dampers,

FIGS. 5a-d show the comparison of stroke and pressure curves in a pressure-controlled fuel injection system, with and without oscillation dampers,

FIG. 6 shows another embodiment of the damping bypasses in devices that connect high-pressure lines to each other, and

FIG. 7 shows a comparison of damping behaviors according to various embodiments of the invention.

### EMBODIMENT VARIANTS

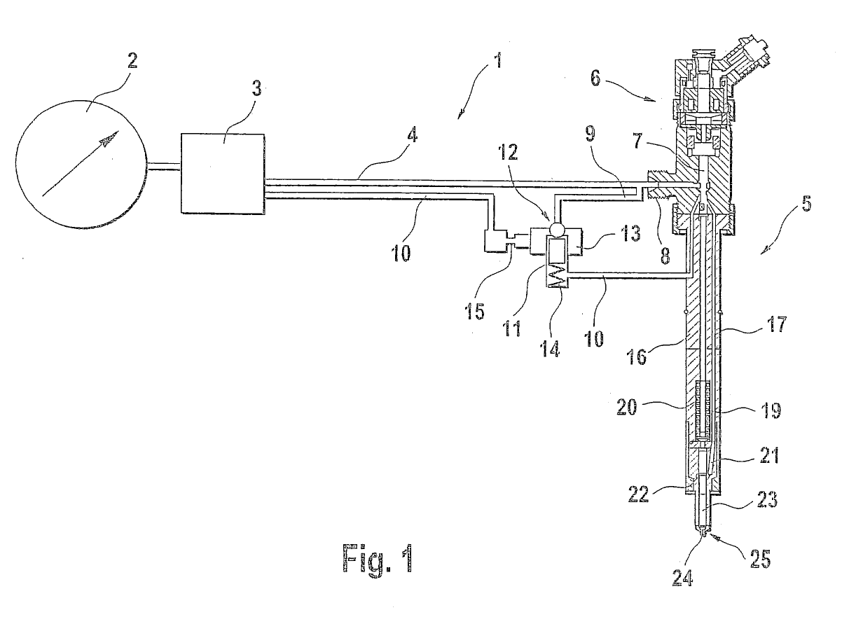

FIG. 1 shows a schematic view of the essential components of a pressure-controlled first injection system for injecting highly pressurized fuel into combustion chambers of internal combustion engines.

The depiction according to FIG. 1 shows a fuel injection system 1 designed according to the invention, which includes a pump 2 that compresses the fuel to a pressure level of 1350 bar, for example. The fuel thus compressed is pumped into a high-pressure accumulation chamber 3 (common rail) in which this high pressure continuously prevails. A high-pressure line 4 leads from the high-pressure accumulation chamber 3 to an injector 5 on which an injection nozzle 24 is embodied.

In the upper part of the injector 5, a solenoid valve 6 is provided, which functions as an actuating mechanism for a metering valve 7, which can be embodied, for example, as a 3/2-port directional-control valve. The metering valve 7 moves a valve body inside the housing of the injector 5 essentially in the vertical direction, permitting a high-pressure line 17 extending to a nozzle chamber 22 to be acted on with highly pressurized fuel.

The high-pressure supply line 4 extending from the high-pressure accumulation chamber 3 feeds into the housing of the injector 5 in the vicinity of a high-pressure connection 8.

Inside the housing of the injector 5, a return line 10 extends from the metering valve 7 and contains a damping valve 11 in the embodiment according to FIG. 1. In addition to a ball element 12, which serves as a check valve and is acted on by a pressure element 13, the damping valve 11 includes a spring element 14, which can be used to adjust the closing pressure of a branch 9 that can be closed by the ball element 12 at one end and at the other end, feeds into the high-pressure supply line 4 that extends to the housing of the injector 5.

In the vicinity of the return line 10, which extends from the damping valve 11 to the high-pressure accumulation chamber, a damping throttle 15 is provided, whose throttle cross section is dimensioned so that it does not impair the continuous high pressure at the metering valve 7, i.e. in the nozzle chamber 22 of the injector 5, that is produced during the high-pressure injection phase. With high pressures in the high-pressure accumulation chamber and low injection quantities in injection nozzle 24, the damping throttle 15 contained in the return line 10 to the accumulation chamber 3 (common rail) reduces an excessive pressure increase at the metering valve 7 after the closing. The outflow of highly pressurized fuel, which travels through the damping throttle 15 either into the high-pressure accumulation chamber 3 or via a connection fitting into the high-pressure line 4, can significantly reduce the pressure increase occurring so that the material stress of the components used in the fuel injection system 1 does not exceed permissible limits and therefore the service life remains assured.

For the sake of completeness, it should be noted that the high-pressure supply line 17 extends from the metering valve 7 (3/2-port directional-control valve) in the housing of the injector 5 to the nozzle chamber 22. The spring element 20 is contained in a cavity 19 in the housing of the injector 5. A nozzle needle extends in the housing 19. The nozzle chamber 22 encloses the nozzle needle 23 in the vicinity of a step; from the nozzle chamber 22, the nozzle needle extends with a tapered diameter to the injection nozzle tip 24. At the nozzle tip 24, the nozzle needle tip is moved into a seat 25, which is opened or closed depending on the injection cycle by the vertical movement of the nozzle needle 23.

The damping throttle 15 contained in the return line 10 from the metering valve 7 into the high-pressure accumulation chamber 3 or into the high-pressure line 4 can be permanently activated; it is also possible, by means of the damping valve 11, to connect the return flow of fuel via the return line 10 into the high-pressure accumulation chamber 3 through an additional valve by means of the damping valve 11 so that the damping valve 11 cannot produce any pressure decrease during the injection phase. After the injection is finished, the damping valve 11 can open again after the end of the fuel injection so that a controlled pressure decrease can take place by means of the throttle element 15 in the return line 10 to the high-pressure accumulation chamber 3 or in the high-pressure line 4. This is quite possible in this phase position since pressures on the order of 1800 bar prevail at the metering valve, compared to a continuous pressure of 1350 bar in the reservoir.

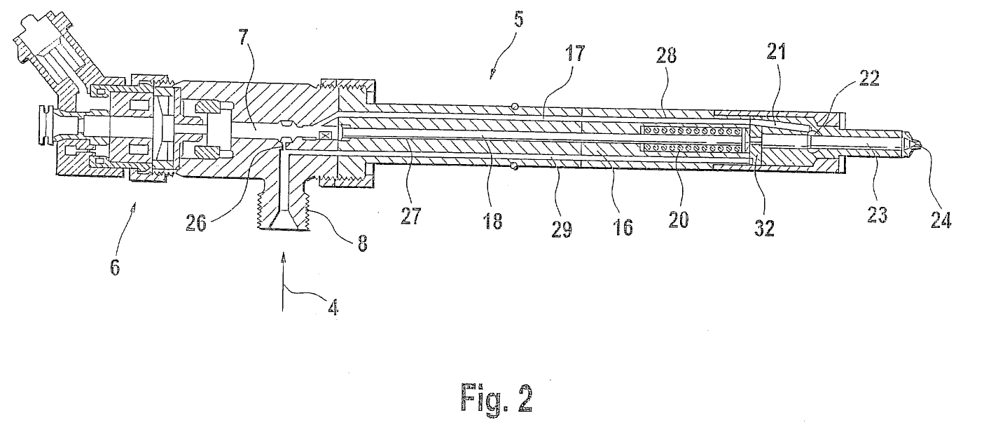

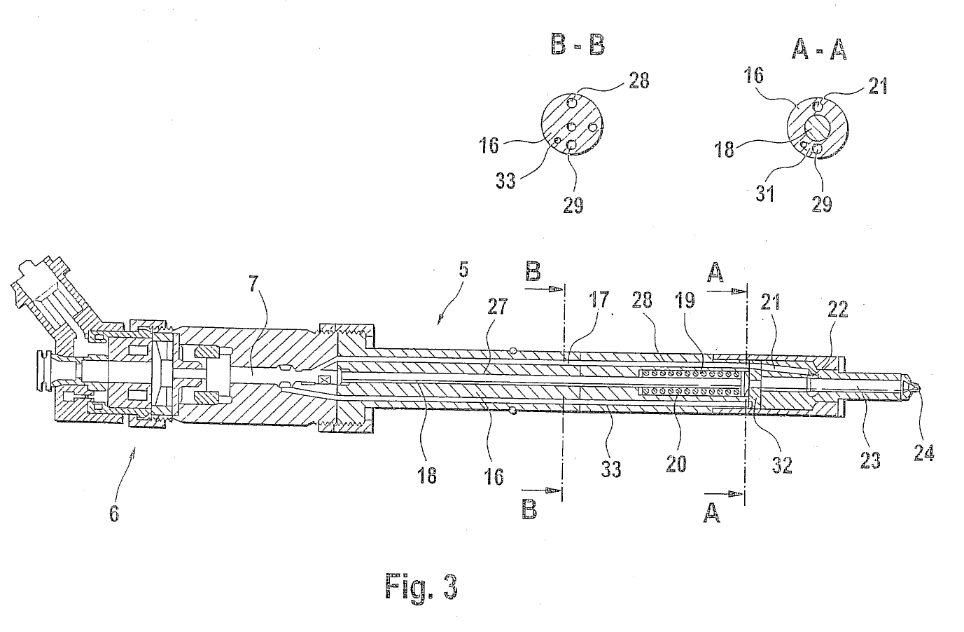

FIGS. 2 and 3 give detailed depictions of different views of an injector body of a fuel injection system according to the invention, in which, by contrast with FIG. 1, the damping function is integrated into the injector.

FIG. 2 shows a first longitudinal section through an injector 5 in which the high-pressure connection 8 contains a high-pressure supply line 4 from which a damping throttle 26 feeds into the valve chamber in the metering valve 7. The metering valve 7 is connected to the high-pressure line 4 by means of the bores 29 and 33 (see FIG. 3). The opening and closing movement of the control body of the metering valve 7 is produced by means of a solenoid valve 6 in the design of the injector according to FIG. 2. A piezoelectric actuator or another actuating unit with short reaction times can also be used instead of the solenoid valve 6 shown here. Starting from the metering valve 7, the high-pressure supply line 17 extends to the nozzle chamber 22, which encompasses the nozzle needle 23 in an annular fashion. The injection nozzle 24 is disposed at the end of the nozzle needle 23, which protrudes into the combustion chamber of an internal combustion engine. The housing interior 16 of the injector 5 contains a cavity 19, which contains a compression spring element 20. In the design of the housing 16 of the injector 5 according to FIG. 2, a disk-shaped dividing element in the form of a ring 32, which contains a connecting groove 31, is disposed between the housing 16 and the nozzle needle 23. The connecting groove 31 serves to connect the bores 29 and 33.

The depiction according to FIG. 3 shows an injector whose cross sectional position is slightly rotated in comparison to the one shown in FIG. 2.

This depiction shows the connecting bore 33 in more detail. The damping throttle 26 serves to damp pressure oscillations in the supply line. These pressure oscillations occur due to the rapid opening of the valve between the high-pressure accumulation chamber 3 and the metering valve 7. The pressure upstream of the entry into the bore 29 is higher or lower than in the metering valve 7; the damping throttle 26 produces a pressure balancing, which intentionally damps the oscillations. The damping throttle 26 must be designed so that the pressure increase is not damped too intensely, but a sufficient damping is achieved after the end of the injection phase.

This variant in which the fuel is not supplied to the metering valve 7 directly from the high-pressure line 4, but is diverted by means of the bores 29 and 30, offers two advantages:

The length of the fuel path, which is relevant for the injection pressure curve and extends from the high-pressure accumulation chamber 3 to the metering point, is composed of the line length and the lengths of the two bores 29 and 33. The line can be embodied as shorter than would be the case without the two bores 29 and 33. Moreover, the damping function can be integrated directly into the injector in the manner described above with the aid of the damping throttle 26.

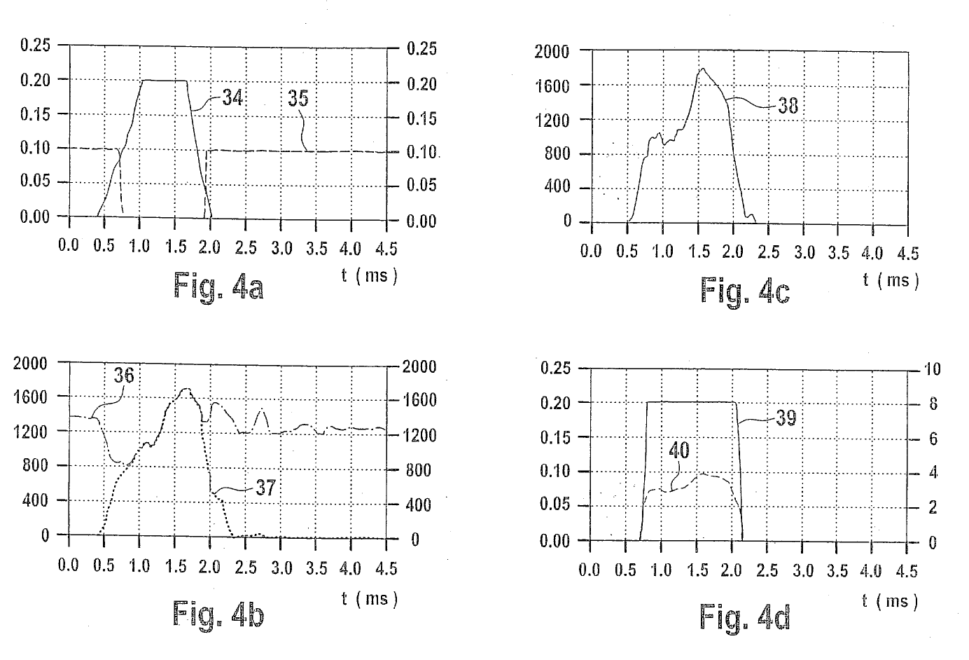

FIGS. 4a and 4b give a detailed depiction of the stroke and pressure curves of a pressure-controlled injection system with oscillation and pulsation dampers, as described in conjunction with FIG. 1.

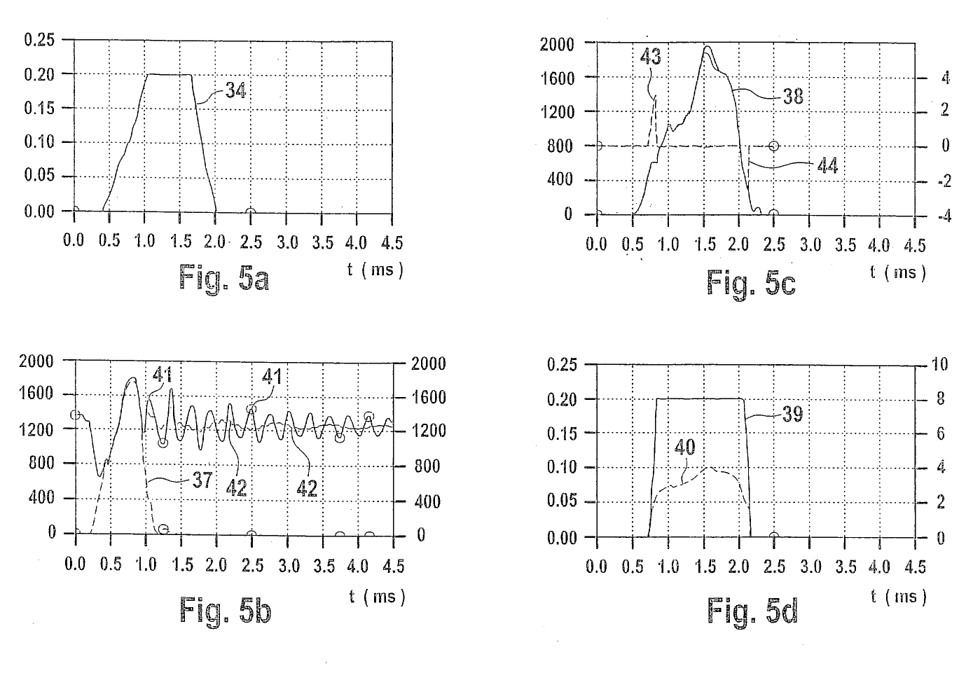

FIG. 4a shows the control piston stroke path 34 that occurs and the damper stroke 35, plotted over the time axis. After the start of the control piston stroke path 34, the damper stroke 35 returns to the zero level. The graph below this in FIG. 5b gives a detailed depiction the curve of the pressure 36 upstream of the metering valve 7 and the pressure curve downstream of the metering valve 7, which is depicted with the curve indicated at position number 37. The movement of the control piston according to curve 34 from graph 4a triggers a sharply pronounced pressure increase according to curve 36 when the metering valve 7 is triggered. However, when the metering valve 17 closes again, then according to curve 37, a rapid pressure decrease to the zero level occurs and the damper lifts up again according to curve 35. According to the further progression of curve 36 in FIG. 4b, a damped pressure oscillation remains present in the line system. According to curve 38 from the depiction in FIG. 4c, the pressure in the nozzle chamber increases continuously, analogous to the pressure curve upstream of the metering valve 7 according to curve 36 in FIG. 4b. The pressure maximum according to curve 38 is over 1600 bar of nozzle pressure.

In FIG. 4d, the reference numeral 40 indicates the injection rate of fuel into the combustion chamber of the internal combustion engine. During the trapezoidal curve of the needle stroke of the nozzle needle 23 in the housing 16 of the injector 5, i.e. during the vertical motion of the nozzle needle 23, the injection rate into the combustion chamber of an internal combustion engine according to curve 40 is reduced. The nozzle needle 23 therefore unblocks the nozzle seat 25 of the injection nozzle 24 precisely when, according to curve 38, the pressure in the nozzle chamber 22 in the injector housing 16 of the injector 5 exceeds the nozzle opening pressure. The damping function is therefore suppressed during the injection in the desired fashion, as can be seen from the control piston stroke path 34 according to FIG. 4a.

The stroke and pressure curves shown in FIGS. 5a to 5d show pressure curves that occur in the pressure-controlled fuel injection system, with and without oscillation dampers. The curve of the control piston stroke motion 34 according to FIG. 5a essentially corresponds to the progression according to the curve in FIG. 4a; FIG. 5b depicts the pulsations, labeled with the reference numerals 41 and 42, that occur in the line system of the fuel injection system 1 after the metering valve 7 closes. Reference numeral 41 indicates the oscillation that is virtually undamped by the weak friction present in line systems of a fuel injection system without a damping throttle and without a damping valve. By contrast, reference numeral 42 indicates the progression of the pressure oscillation, which, after two more powerful spikes upon closing of the metering valve 7, assumes a nearly smooth and linearly extending curve. The material stresses occurring in a line system, which experiences a pressure pulsation according to curve 42, differ significantly from the material stress that accompanies the pressure pulsations according to curve 41. The service life of an injection system depends to a considerable degree on the peak pressures that occur, which when the oscillations are undamped, can almost reach the pressure level in the line system that prevails during the injection phase in the injection nozzle. But the line system of a pressure-controlled fuel injection system is not designed to withstand this for long. Moreover, a precise metering of the fuel requires a decay of the pressure oscillation from the prior injection.

From the graph according to FIG. 5c, analogous to FIG. 4c, the reference numeral 38 indicates the pressure curve prevailing in the nozzle chamber, whereas the reference numerals 43 and 44 indicate the opening and closing speeds of the nozzle needle 23 in the vertical direction in the injector housing 16.

FIG. 5d shows the injection rate 40 that occurs during the needle stroke motion 39.

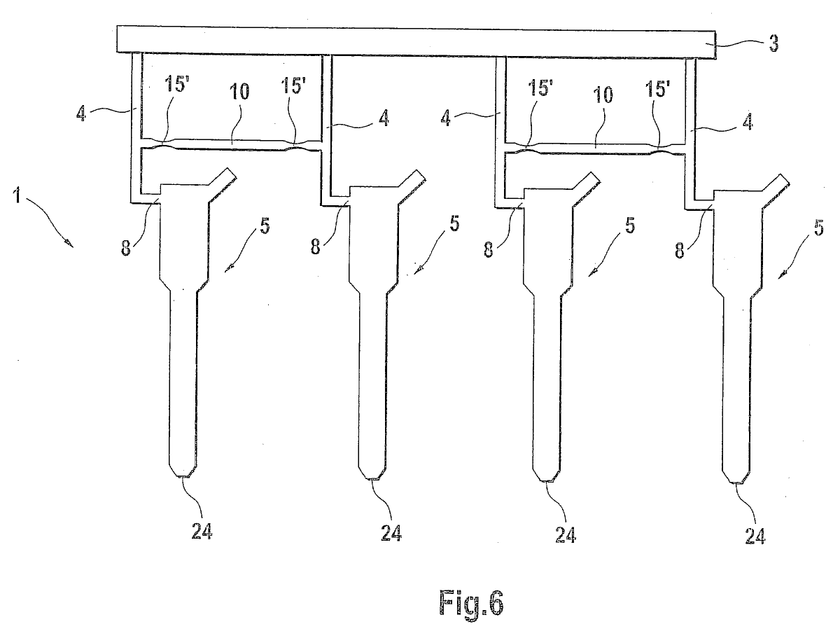

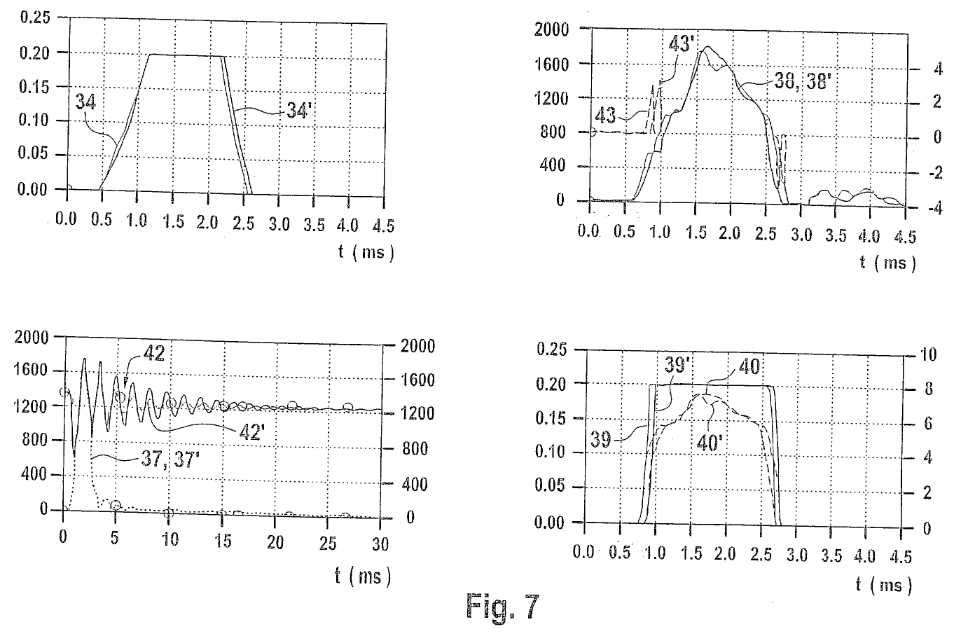

FIG. 6 schematically depicts an alternative embodiment of the damping system for fuel injection systems proposed according to the invention. Starting from the high-pressure accumulation chamber 3 (common rail), the high-pressure supply lines 4 extend to the individual injectors 5, whose ends on the nozzle end 24 protrude into the combustion chambers of the internal combustion engine. According to the depiction in FIG. 7, the high-pressure lines 4 leading to two injectors 5 are connected to each other in pairs by means of a damping line 10. At the respective beginning and end of this damping line 10, throttle elements 15 are accommodated in the flow cross section of the damping line 10; in order to accommodate the damping line 10 between two high-pressure supply lines 4, these supply lines need only be modified through the provision of connecting pieces (T-pieces) for the installation of the damping line 10 according to FIG. 6. The injectors 5 according to the fuel injection design from FIG. 6 can remain unchanged; only the supply lines from the high-pressure accumulation chamber 3 to the high-pressure connections 8 of the injectors 5 need to be modified, the injectors 5 themselves do not. The essential advantage therein is that the damping lines 10 according to FIG. 6 can be used in all high-pressure accumulation chamber reservoir injection systems and are independent of the injectors. The moment an injector 5 injects, it produces a pressure oscillation in the respective high-pressure line 4. As a result, a pressure gradient is produced between the two high-pressure lines 4 of the respective injectors 4 that are connected to each other by means of the damping line 10, and as a result, a balanced flow via the throttle elements 15′ in the damping lines is produced. This hydraulic “short circuit” decreases oscillation energy in the respective throttle elements 15′ and effectively damps the oscillation.

FIG. 7 gives a detailed depiction of the stroke and pressure curves occurring in the embodiments of the fuel injection system according to FIGS. 2, 3, and 6. The reference numerals without the prime symbols relate to the pressure and stroke curves of a fuel injection system according to FIGS. 2 and 3, whereas the identically selected reference numerals with the prime symbols relate to the stroke and pressure curves of a design according to the depiction in FIG. 6.

The control piston stroke curves 34 and 34′ are virtually identical, whereas the pulsation curves indicated with reference numerals 42 and 42′ differ from each other with regard to the decay of the oscillation. In the pressure curve labeled with the reference numeral 42′, in the components of a fuel injection system, the oscillations decay more rapidly due to the fact that two high-pressure lines 4 of an injector pair 5 are to connected to each other in short circuit fashion. After an interval of up to 10 milliseconds, the oscillation in the system has reached a non-critical amplitude and it can therefore be referred to as a steady state. Reference numerals 37 and 37′ indicate the pressure curves after the closing of the metering valve 7 in the designs according to FIG. 7 and FIG. 1. Immediately after the end of the triggering of the valve body of the metering valve 7, due to the sluggish damping action, a maximum of the pressure pulsation occurs in the line system.

The pressure curves 38 and 38′ occurring in the nozzle chamber are virtually identical; the reference numerals 43 and 43′ indicate the closing and opening of the injection nozzle at the nozzle tip 24.

The injection rates 40 and 40′ of the two embodiments of the injection system designed according to the invention are virtually identical; the needle stroke paths 39 and 39′ are slightly offset from each other.

1. A device for injecting fuel into the combustion chambers of an internal combustion engine, with a pump (2), which supplies highly pressurized fuel to a high-pressure accumulation chamber (3), from which a high-pressure line (4) leads to an injector (5) and contains a valve for fuel metering, characterized in that upstream of the valve, a damping throttle element (26) is provided, which feeds into another part of the high-pressure region (4) directly or by means of a return line (10).

2. The device according to claim 1, characterized in that the return line (10) feeds into the high-pressure accumulation chamber (3).

3. The device according to claim 1, characterized in that the return line (10) feeds into the high-pressure supply line (4) to the injector (5).

4. The device for injecting fuel according to claim 1, characterized in that the return line (10) contains a damping throttle (15) and a damping valve (11).

5. The device according to claim 4, characterized in that the damping valve (11) can be closed by the nozzle pressure downstream of the metering valve (7).

6. The device according to claim 1, characterized in that the damping throttle (26) at the metering valve (7) feeds into the high-pressure supply line (4).

7. The device according to claim 6, characterized in that throttle elements (15′) are contained at the beginning and end of the damping line (10) of the high-pressure lines (4).

8. The device according to claim 1, characterized in that the damping elements (15, 15′) are contained in the high-pressure part of the fuel injection system (1).
